(19) United States
(12) Patent Application Publication
(10) Pub. No.: US 2023/0125923 A1
(43) Pub. Date: Apr. 27, 2023

(54) METHOD FOR ESTIMATING A SERVICE INTERVAL FOR REPLACING AN AQUEOUS LIQUID FILTRATION DEVICE IN A MOTOR VEHICLE

(71) Applicant: ActBlue Europe S.a r.l., Senningerberg (LU)

(72) Inventors: Charles-Albert FISCHBACH, Toulouse (FR); Romain JACQUES, Toulouse (FR); Cédric LORENZON, Toulouse (FR)

(21) Appl. No.: 17/911,856

(22) PCT Filed: Mar. 15, 2021
(86) PCT No.: PCT/EP2021/056492

§ 371 Date: Sep. 15, 2022

(30) Foreign Application Priority Data
Mar. 18, 2020 (FR) FR2002623

(51) Int. Cl. G07C 5/00; F01N 3/20; G07C 5/08; B01D 35/143; B01D 35/26

(52) U.S. Cl. CPC G07C 5/006; F01N 3/208; G07C 5/0808; G07C 5/0825; G07C 5/085; B01D 35/143; B01D 35/26; F01N 2610/1433; F01N 2610/1426; F01N 2610/1406; B01D 53/9418

(57) ABSTRACT

A method for evaluating a service interval for replacing a filter of a system for extracting an aqueous liquid from a motor vehicle tank in response to the risk of progressive clogging of said filter from use. A compound clogging risk decision value (K) is generated (320) on the basis of the sum of a plurality of elementary values (k1, k2, k3, k4) of the clogging risk, each related to a risk criterion depending on the operation of the extraction system since commissioning of the filter. The compound clogging risk decision value is compared (340) to a threshold value, and an alert to replace the filtration device is generated (351, 352) if the compound clogging risk value exceeds the threshold value.

### TECHNICAL FIELD

The present invention generally relates to systems for extracting aqueous liquids from motor vehicle tanks. It relates more particularly to the evaluation of a service interval for replacing a filtration device of such an aqueous liquid extraction system.

The invention has application, in particular, in exhaust gas treatment systems in motor vehicles equipped with a diesel engine, for example in light vehicles, utility vehicles or lorries (or heavy goods vehicles) comprising such an engine. In these examples of applications, the aqueous liquid concerned is liquid additive extracted from a dedicated tank and injected into the flow of exhaust gases to clean said exhaust gases.

### PRIOR ART

The exhaust gases generated by vehicles with compression ignition engines (known as diesel engines) or by vehicles with spark ignition engines (known as petrol engines), consist in particular of atmospheric pollutant gases such as carbon oxides (COx for CO and CO2) and nitrogen oxides (NOx for NO and NO2). Diesel engines, in particular, are regulated to reduce the amount of polluting gases they emit. One example is the regulations capping the levels of nitrogen oxides emitted. They tend to be ever more restrictive.

The cleaning of engine exhaust gases in vehicles equipped with diesel engines, which is already regulated, and in vehicles equipped with petrol engines, which could soon become regulated, can be carried out by means of a gas treatment system implementing a pollution control method such as selective catalytic reduction (SCR). The SCR method uses a decontaminating liquid additive to selectively reduce the nitrogen oxides (NOx) contained in the exhaust gases. Decontaminating liquid additive means a decontaminating product that can be injected into an exhaust gas treatment device of an engine to clean the exhaust gases before they are discharged into the atmosphere.

The liquid additive commonly used in the SCR method is an aqueous liquid called diesel exhaust fluid (DEF). This liquid additive is more precisely a 32.5% by weight aqueous solution of urea, also marketed under the AdBlue® brand, which is a precursor of ammonia (NH3). In this context, the thermal energy provided by the exhaust is a catalyst for the transformation of DEF into ammonia. The ammonia reacts with the nitrogen oxides (NOx) of the exhaust gases to produce less polluting species, namely diatomic nitrogen (N2), water and carbon dioxide (CO2). Thus, the ammonia used in the SCR method is a reducing agent, supplied as a liquid additive.

In vehicles fitted with an exhaust gas treatment system, the liquid additive is generally stored in a dedicated tank. The additive is extracted from the tank by an extraction system which notably comprises a pump adapted to cause it to circulate in a hydraulic circuit, with a certain flow rate, to an injector. This injector has the function of spraying the correct amount of additive, at any given time, into the flow of exhaust gas in the form of micro-droplets, controlled by a control unit. The function of the control unit is to dose the amount of additive to be injected according to the actual needs of the exhaust gas treatment system, and to control the injector accordingly. This metering and this control are carried out according to parameters such as, for example, the temperature of the liquid additive or the hydraulic pressure at a given instant.

In addition to the pump, an extraction system generally comprises at least one device for filtering the liquid additive. The main filtration device is located upstream of the pump in the hydraulic circuit. This position reduces the risk that the liquid reaching the pump and later the injector is contaminated by impurities (for example dust or particles in suspension). Such contamination could in fact lead to a deterioration in the performance of the extraction system and, more broadly, of the exhaust gas treatment system as a whole. Typically, in all-terrain vehicles equipped with an exhaust gas treatment system and used off-road, for example at a mining quarry or construction site, it is common for the liquid additive contained in the dedicated tank to be contaminated with such impurities. Integrating a filtration device in the system makes it possible to maintain the level of performance of the exhaust gas treatment system for an optimum period despite possible contamination of the liquid with impurities.

However, the performance of the filtration devices themselves is known to deteriorate with use. In particular, as a stream of contaminated liquid passes through a filtration device, impurities can accumulate at the level of said filtration device. However, this progressive clogging, or even clogging of the filtration device degrades the performance of the exhaust gas treatment system.

Thus, when a filtration device exceeds a certain level of clogging it must be dismantled and replaced to allow the exhaust gas treatment system to maintain a sufficient level of performance with regard to the applicable regulations.

However, the dismantling operations required to remove the filtration device from the extraction system can be long and tedious. Most of the time they also involve immobilising the vehicle for a long time. Thus, in such an extraction system, the decision of when to replace the filtration device is critical.

In practice, however, the filtration device is replaced considering only the absolute time elapsed since its last replacement, or the amount of fluid consumed by the exhaust gas treatment system. When one of these reference items of information exceeds a certain threshold, this is considered an indication that the level of clogging of the filtration device calls for its replacement. However, this is only a presumed clogging level, because no effective measurement of the actual clogging of the filtration device is carried out given that no measurement technique under real conditions of use of the filtration device is known that is both technically and economically feasible on the one hand, and sufficiently reliable on the other.

However, the speed at which the filtration device is likely to become clogged is highly variable, depending on the type of vehicle on which the liquid extraction system is installed and depending on the use made of this vehicle. Thus, for example, a construction machine used in building areas or logging or mining areas is more likely to have debris (soil, sand, dust, etc.) entering the tank during a filling on site than a road transport lorry that fills its liquid tank at service stations whose state of cleanliness can be much higher. Similarly, a public transport bus used in an urban environment consumes much more liquid additive for the treatment of exhaust gases than a tourist coach making long-distance journeys at regular speed on the motorway.

In other words, the clogging of the filtration device can only be correlated with the time that has elapsed since its last replacement or with the amount of fluid consumed by the system incorporating it by making very approximate assumptions. These hypotheses are in fact only based on an average duration of use and on standard conditions of use relative to a large number of vehicles, possibly the entire fleet of vehicles using a given model of filtration device.

Therefore, the criteria for determining clogging risk used in the prior art are static and universal, in the sense that they are established once and for all and in the same way for an entire fleet of vehicles. It follows that the decision to replace a filtration device is taken in each case only in a relatively random manner with regard to the real need to carry out such a replacement, given the effective level of clogging of the specific filtration device being considered.

Consequently, filtration devices are probably replaced too soon, whereas they could be longer in the interests of saving money, limiting vehicle downtime and reducing the volume of contaminated filtration devices to be recycled. Conversely, filtration devices are certainly replaced too late, when their clogging has already caused a degraded performance of the exhaust gas treatment systems that incorporate them, with the harmful consequence of greater pollution of the atmosphere by the vehicles concerned.

We know document US 2015/218990 A1, which uses a secondary tank to compare a theoretical filling level thereof with the actual filling level, measured using a sensor in order to determine the permeability of the filter.

Document FR2787143 A1 is also known, which refers to a method for detecting the clogging of a fuel filter, and which essentially consists in directly measuring the pressure drop around the filter using a pressure sensor and a booster pump model based on pump speed and thermal characteristics.

We also know document DE112013001605 T5, which refers to a method for detecting the clogging of a fuel filter by monitoring the voltage of an electric motor, and seems to show that the clogged filter is detected by monitoring the supply current of the booster pump compared to a standard level.

Finally, we know document DE19716979 A1, which seems to focus on monitoring only the delta p to assess the clogging of the fuel filter.

### DISCLOSURE OF THE INVENTION

The invention mitigates the aforementioned drawbacks of the prior art and aims to improve the existing methods by proposing a method that enables dynamically and individually evaluating a service interval for replacing a filtration device of an aqueous liquid extraction system for a motor vehicle tank.

“Service interval” means information that indicates to the user that it is time to replace the filter. If we consider the time elapsed from the installation of the filter to be replaced to the moment when the indication for replacement is given to the user, the service interval is a time interval. However, those skilled in the art will appreciate that the information corresponding to the service interval for filter replacement is not, mathematically, equal to a specific duration. It is statistical information, which can be expressed for example by a standardised value between 0 and 1, or by a percentage between 0% and 100%, which amounts to the same thing, and which takes into account the clogging risk of the filter at a given time. In the aforementioned examples, the risk would be minimum, for example, for a standardised value equal to 0 or a percentage equal to 0%, and would be maximum for a standardised value equal to one or a percentage equal to 100%.

More particularly, a first aspect of the invention proposes a method for evaluating a service interval for replacing a filtration device of a system for extracting an aqueous liquid from a motor vehicle storage tank in response to the risk of progressive clogging of said filtration device from use, comprising:
generating a compound clogging risk decision value based on the sum of a plurality of elementary clogging risk values, at least one of said elementary values being linked to a risk criterion depending on the operation of the extraction system since the commissioning of the filtration device;
comparing the compound clogging risk decision value with a threshold value; and
producing an alert for replacing the filtration device if the compound clogging risk value exceeds the threshold value,
   wherein the plurality of elementary clogging risk values comprises:
a value (k2) representing the clogging risk linked to the volume of liquid pumped by the pump since the last filling of the tank, and
a value (k3) representing the clogging risk linked to the number of times the tank has been filled since the commissioning of the filtration device.

Those skilled in the art will appreciate that the decision to replace the filtration device remains based on a statistical approach, but that the level of confidence associated with this decision-making is much higher than with the criteria of the prior art. Indeed, the filtration device can be replaced based on a clogging risk decision value which depends on the operation of the extraction system, for the vehicle specifically considered, since the commissioning of the filtration device.

The filtration device can thus be used for an optimal duration, that is, neither too short nor too long. In other words, implementation of this method makes it possible to replace the filtration device without unnecessary anticipation or risky delay in relation to the risk of its effective clogging. Furthermore, in the embodiments, the method can be configured beforehand so that it adapts to the type of vehicle on which the system is installed, and/or to its actual conditions of use.

Embodiments taken alone or in combination further provide that:
the extraction system may further comprise a pump with a first port connected to the tank via the filtration device and a suction line and a second port connected to an injection device via a delivery line, as well as a return line connected to the delivery line by its first end and opening into the tank by its second end, the filtration device being arranged on the suction side of the pump, the plurality elementary clogging risk values can comprise a value representing the clogging risk linked to the volume of liquid pumped by the pump since the commissioning of the filtration device;
the plurality of elementary clogging risk values can comprise a value representing the clogging risk linked to the variation in the pressure difference of the liquid on either side of the filtration device;
a variation in the pressure difference of the liquid on either side of the filtration device can be evaluated as a function of the variation in the operating speed of the pump at a given operating point;
a variation in the pressure difference of the liquid on either side of the filtration device can be evaluated provided that a determined minimum volume of fluid has been pumped by the pump since the commissioning of the filtration device or since a previous assessment;
the elementary clogging risk values can be configured according to the type of vehicle and/or according to the type of use expected of the vehicle;
the alert for replacing the filtration device can be displayed via a man/machine interface of the vehicle, to indicate to a vehicle user the need to replace the filtration device; and/or,
the alert for replacing the filtration device can be stored in a non-volatile memory of the vehicle, to indicate to an operator responsible for the maintenance of the vehicle the need to replace the filtration device.

In a second aspect, the invention also relates to a device comprising means for implementing all the steps of the method according to the first aspect. Such a device can be implemented, in whole or in part, in a control unit of a system for extracting a liquid from a tank of a motor vehicle.

In a third aspect, the invention also relates to a system for extracting a liquid from a tank of a motor vehicle comprising a pump and a filtration device, said pump comprising a first port connected to the tank via the filtration device and a suction line and a second port connected to an injection device via a discharge line, said extraction system further comprising a return line connected to the delivery line by its first end and connected to the tank by its second end, and a device according to the second aspect for evaluating a service interval for replacing the filtration device.

For example, this extraction system can be adapted to extract liquid additive from a dedicated tank of a motor vehicle and to inject said liquid additive into an exhaust gas treatment system of said motor vehicle.

A fourth aspect of the invention relates to an exhaust gas treatment system of a motor vehicle, comprising a system for extracting an aqueous liquid from a tank of said motor vehicle according to the third aspect above.

Finally, a fifth and last aspect of the invention further relates to a computer program product comprising one or more sequences of instructions stored on a memory medium readable by a machine comprising a processor, said sequences of instructions being adapted to carry out all the steps of the method according to the first aspect of the invention when the program is read from the memory medium and executed by the processor.

### DESCRIPTION OF THE DRAWINGS

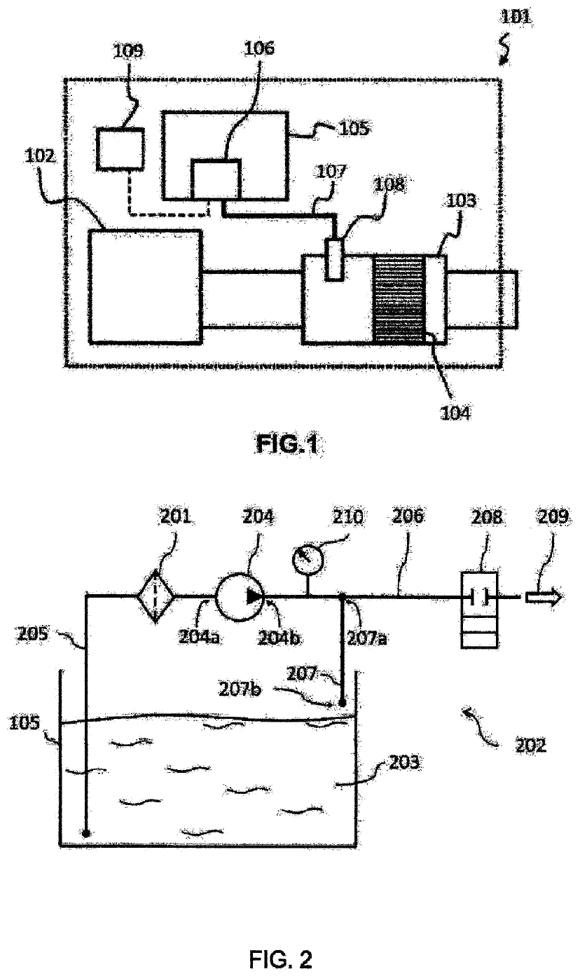

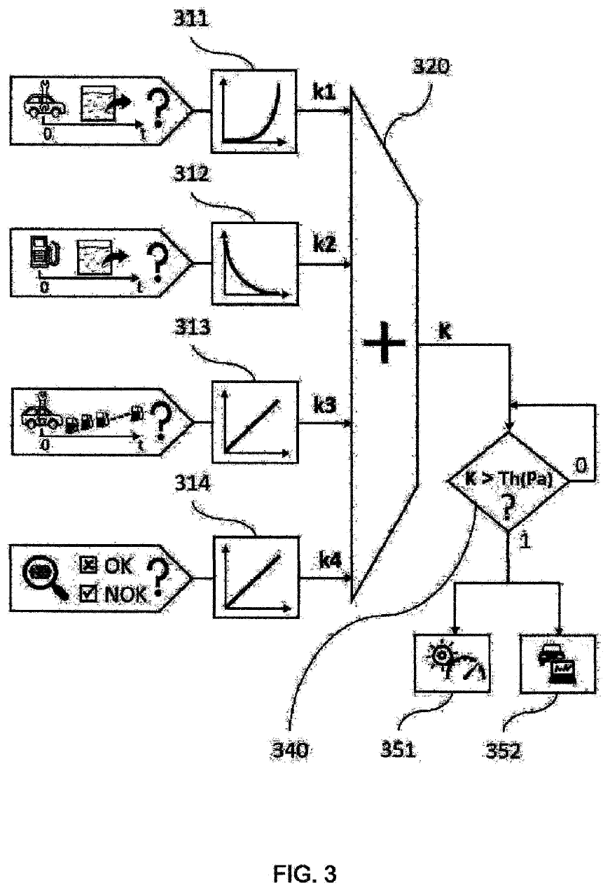

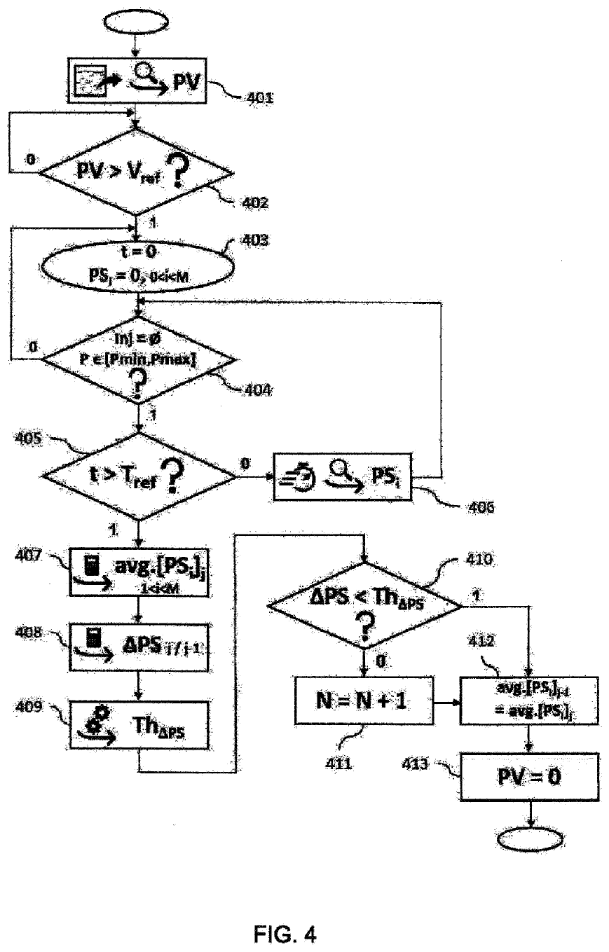

Further features and advantages of the invention will become clear from reading the following detailed description. This is purely illustrative and must be read in conjunction with the appended drawings, in which:

[FIG. 1] is a block diagram of a motor vehicle engine with an exhaust gas treatment device for NOx reduction;

[FIG. 2] is a schematic representation of a system for extracting a liquid from a motor vehicle tank according to one embodiment of the invention;

[FIG. 3] is a diagram of the steps of an embodiment of the method for evaluating a service interval for replacing a filtration device according to the invention;

[FIG. 4] is a diagram of the steps of a method of implementing the determination of an elementary value of the clogging risk linked to the number of negative results, since the commissioning of the filtration device, of a test of the variation of the pressure drift of the liquid downstream of the filtration device carried out at specific time intervals.

### DESCRIPTION OF THE EMBODIMENTS

In the following description of embodiments and in the figures of the appended drawings, the same or similar elements bear the same reference numerals as in the drawings.

FIG. 1 schematically shows a motor vehicle 101 with an internal combustion engine 102, for example a diesel engine. The motor vehicle 101 is for example a passenger car, a utility vehicle, a lorry or a coach. The motor vehicle 101 also includes an exhaust gas treatment system 103 with a catalytic converter (or catalyst) 104 for implementing the cleaning method known as SCR. The vehicle 101 includes a tank 105 for the liquid additive. The tank 105 is connected to an injector 108 to spray the liquid additive into the gas treatment system 103 via a line 107. The injector is supplied with liquid additive under pressure by a pump which is for example integrated into a liquid additive metering module 106 located in the tank 105.

When the engine 102 is in operation, it produces exhaust gases, which are directed to the exhaust gas treatment system 103. The exhaust gas treatment system 103 is supplied with liquid additive through a hydraulic circuit formed by the pump integrated into the module 106, the line 107 and the injector 108. The injector 108 sprays the decontaminating solution upstream of the catalyst 104 in order to cause the selective catalytic reduction of NOx according to the SCR method. The exhaust gases are thus cleaned.

The liquid additive is extracted from the tank 105 and injected into the exhaust gas treatment system 103 only when necessary, and only in the amount necessary to produce a reaction adapted to the amount of exhaust gases produced in each instant by the engine 102 to avoid injecting excess additive, which is potentially responsible for excess ammonia production and useless liquid additive consumption. All the liquid additive metering and pump control operations are controlled by a control unit 109.

Referring to FIG. 2, we will now describe a schematic representation of a system for extracting an aqueous liquid from a motor vehicle tank according to one embodiment of the invention. In the example shown, the extraction system 202 is a hydraulic circuit which has the function of conducting decontaminating liquid additive 203 from tank 105 in which it is stored to the injector 208 which delivers it by spraying to an exhaust gas treatment system or a decontamination system such as that shown in FIG. 1. Those skilled in the art will appreciate that, in addition to this particular example, such an extraction system can be used to extract another aqueous liquid from a tank of a motor vehicle to be injected, for example, after filtration into another system by any injection device.

In the non-limiting example shown, the aqueous liquid, for example DEF sold under the Adblue® brand, is stored in the tank 105 from which it is extracted by the extraction system 202 at the times and in the amount necessary, to be injected into the flow of exhaust gases at the decontamination system. More specifically, in the so-called injection configuration, the aqueous liquid 203 is driven by the pump 204 from the tank 105, into the suction line 205, then through the filtration device 201 and the pump 204 itself and then, pressure side, through the pressure line 206 to the injector 208. The liquid located between the pump and the injector is therefore pressurised liquid. The filtration device 201 is a filtration device conventionally used to filter any impurities present in the aqueous liquid contained in the tank 105, as described in the introduction.

The injection devices such as the injector 208 alternate opening phases and more or less rapid closing phases allowing the spraying of the liquid symbolised by the arrow 209. Therefore, a return line 207 forms a closed loop in the extraction system to re-inject the pressurised liquid into the tank when the injector is closed. In particular, one end 207a of the return line 207 is connected to the pressure line 206 while the other end 207b of the return line opens into the tank 105.

The aqueous liquid extraction system of FIG. 2 typically includes a pressure sensor 210 (manometer) arranged downstream of the pump 204 so as to allow measuring the pressure in the pressure line 206. This makes it possible to control the selection of the operating speed of the pump 204 in order to reach and maintain a certain substantially constant operating point (i.e., a certain pressure value) whatever the control of the injector 208 that consumes pressurised liquid in line 206. The excess liquid returns, if necessary, to the tank 105 via the return line 207 provided for this purpose with a calibrated orifice device, having the function of a pressure limiter in the pressure line.

With reference to the process diagram in FIG. 3, we will now describe embodiments of the method according to the invention. The steps of the method can be executed by an extraction system control unit. In a particular embodiment, this may be, for example, a control unit for a metering module of a contaminating gas treatment system of a motor vehicle, such as for example the metering module for liquid additive 106 of the vehicle 1 of FIG. 1.

The method allows producing a clogging risk decision value for a filtration device, or filter, of a system. In the applications considered in this document, the system is for example a system 202 for extracting an aqueous liquid from a motor vehicle tank. Such a decision value is a statistical value.

Nevertheless, unlike known decision values for identical or similar applications which are determined once and for all and in a global and identical manner for an entire fleet of vehicles, this decision value depends on the effective clogging level of each specific filtration device. In addition, it is a compound value, in the sense that it results from taking into account a plurality of elementary clogging risk values that are distinct from one another. These elementary clogging risk values are each linked to a respective risk criterion, and depend on the operation of the extraction system from the time of commissioning of the filter in question, that is, since the commissioning of the vehicle if the filter is the original one, or since its last replacement if not. The use of this filter clogging risk decision value enables evaluating a service interval at which to carry out the first or the next replacement of the filter, respectively, in response to the risk of progressive clogging of said filter from use.

In the example shown in FIG. 3, the compound clogging risk decision value, denoted by the letter K, is based on four elementary clogging risk values, denoted k1, k2, k3 and k4, respectively. These four elementary clogging risk values k1, k2, k3 and k4 are produced independently of one another, during respective steps 311, 312, 313 and 314. The invention does not, however, intend to be limited by the number of elementary clogging risk values taken into account. Other embodiments may take into account only two or three elementary clogging risk values, or conversely more than four such values, to produce the compound value K.

Furthermore, in the example considered here and illustrated by FIG. 3, the compound value K is given by the sum, obtained in step 320, of the elementary values k1, k2, k3 and k4. By “sum”, we mean the simple addition of four values, in the mathematical sense of the term. In other words, in this example we have K=k1+k2+k3+k4. However, this example is not limiting. The value K can also be obtained from a weighted sum of the available elementary clogging risk values of the filter. Such a weighted sum would involve respective weight values affecting each of the elementary clogging risk values. With weights which would on the contrary be identical and inversely proportional to the total number of elementary values taken into account, an average of said elementary values would be obtained. These variants are mentioned here for the sake of avoiding any undue limitation of the embodiments of the method. However, those skilled in the art will appreciate on reading the following that the effects of a weighting or an average of the elementary values can be obtained in a way other than by mathematical calculations, which is more elegant and which allows step 320 to represent an implementation that is the simplest possible in terms of the necessary calculations. In other words, obtaining at step 320 the compound value K from a simple addition of the elementary values k1, k2, k3 and k4 constitutes the least computationally intensive implementation, therefore the simplest and most efficient for an application embedded in a motor vehicle.

Before returning in more detail to each of the elementary values k1, k2, k3 and k4 of the clogging risk of the filter, the description of the steps of the method is continued with the presentation of step 340. At this step 340, the compound decision value K of the clogging risk of the filter is compared to a decision threshold Th of a determined value in order to characterise or not the existence of a clogging risk requiring replacement of the filter. If the decision threshold is exceeded, that is to say if K>Th, the clogging risk of the filter is confirmed. The test of step 340 can be carried out continuously, during operation of the vehicle. In response to a compound clogging risk decision value K of the filter possibly exceeding the decision threshold Th, certain embodiments comprise the production of an alert for replacing the filtration device.

For example, at step 351, such an alert can be displayed via a man/machine interface of the vehicle to indicate the need to replace the filtration device to a vehicle user.

The alert can thus take the form of the lighting of a corresponding indicator light, for example on the dashboard of the vehicle. As a variant or in addition to the light, it may also be a voice message reproduced by a voice synthesiser, for example when the vehicle is stopped and once the vehicle has been completely immobilised, so as not to disturb the driver while driving.

As a variant or in addition to step 351, the method can also comprise a step 352 in which the alert for replacing the filtration device is stored in a memory of the vehicle, namely a non-volatile memory. This makes it possible to indicate the need to replace the filtration device to an operator responsible for the maintenance of the vehicle when said operator connects to the vehicle a test tool capable of reading this memory. This may indeed appear in a test report generated by the test tool.

In examples of implementation of the method, the value of the decision threshold Th can depend on the atmospheric pressure. Indeed, the higher the atmospheric pressure, the greater the pressure difference between the upstream and downstream pressures of a clogged filtration device. In other words, high atmospheric pressure makes it more difficult for the liquid to pass through an already noticeably clogged filter. This is why the decision threshold Th can be varied as a function of ambient pressure Pa. In FIG. 3, the decision threshold is written as Th(Pa) in the test of step 340 to express that the value of the decision threshold Th depends on atmospheric pressure Pa. In an exemplary embodiment, the value Th(Pa) can be given by a look-up table as a function of atmospheric pressure Pa data.

This information can be information representing the ambient pressure measured locally by a pressure sensor placed in the immediate environment of the liquid additive extraction system. It can also be information relating to the atmospheric pressure measured for example in the engine compartment of the motor vehicle, which can be received by the control module implementing the method from another computer of the vehicle, for example via a bus communication. In one example, this other computer may be the engine control computer, which already has this information from a sensor placed in the engine compartment. The communication bus can be a CAN (Controller Area Network) bus.

We will now describe in more detail non-limiting examples of elementary values k1, k2, k3 and k4 of the clogging risk of the filtration device which can be taken into account to calculate the compound value K of said risk. Each of these elementary clogging risk values corresponds to a specific criterion for evaluating the overall clogging risk of the filter. “Risk criterion” means a pre-established criterion on which the control unit executing the method relies to estimate the overall clogging risk of the filtration device. Such a criterion may, for example, be linked to the duration of use of the filtration device, to the conditions of use of the extraction system or to any other information considered significant for estimating the clogging risk of the filtration device. Each of the elementary values k1, k2, k3 and k4 of the clogging risk provides an additive contribution to the compound value K of the clogging risk of the filter.

A first example k1 of an elementary value of the clogging risk of the filtration device can be a value representing the clogging risk linked to the volume of fluid pumped by the pump 204 of FIG. 2 since the commissioning of the filtration device 201. In this regard, with reference to FIG. 2, recall that the pump 204 has a first port 204a connected to the tank 105 via the filtration device and a suction line 205 and a second port 204b connected to an injection device 208 via a discharge line 206, as well as a return line 207 connected to the discharge line 206 by its first end 207a and opening into the tank 105 by its second end 207b. In other words, the filtration device 201 is placed on the suction side of the pump 204 of the extraction device. Thus arranged, it filters all the liquid pumped by the pump, whether it is liquid consumed by the injection device 208 or liquid which returns to the tank 105 via the delivery line 207. The liquid present in the tank is continuously filtered according to a closed loop configuration of the pumping and filtration means. It follows that the volume of liquid filtered by the filter corresponds to the volume of liquid pumped by the pump. Therefore the clogging risk of the filter depends on the volume of liquid pumped by the pump since the installation of the original filter or since the last filter replacement, as applicable.

In an exemplary embodiment, the information k1 representing the clogging risk linked to the volume of fluid pumped by the pump since the commissioning of the filtration device can be given, at step 311, by a look-up table, according to the cumulative operating time of the pump since commissioning. Indeed, the volume of fluid pumped by the pump is proportional to its operating time, to within a ratio corresponding to the theoretical flow rate of the pump. The look-up table can advantageously take into account the value of the theoretical flow rate of the pump, by means of the values actually contained in the table and indexed by the information relating to the operating time of the pump since commissioning of the filter. This time is, for example, counted by a counter of the control module, according to the phases of operation and non-operation of the vehicle, and stored in a persistent memory of the control module.

Those skilled in the art will appreciate that the effects of clogging of the filter due to the volume of fluid pumped by the pump since commissioning of the filter increase with the cumulative operating time of the pump since such commissioning, but do not increase uniformly. Indeed, at the beginning, that is, when the filter is new, the clogging risk is low, even zero. However, after a certain volume of liquid has been filtered, therefore after a certain period of operation of the pump, the clogging risk begins to increase exponentially until the filter is clogged. The form of the response of the look-up table according to the cumulative operating time of the pump since commissioning of the filter is represented symbolically in the block representing step 311 in FIG. 3.

A second example k2 of elementary value of the clogging risk of the filtration device can be a value representing the clogging risk linked to the volume of fluid pumped by the pump since the last filling of the tank. It will be noted that, by filling, we do not necessarily mean here the maximum levelling of the tank, but an operation having the effect of introducing new liquid into the tank, whether or not in an amount sufficient to fill the tank to its maximum level. Thus, the value k2 can be determined even in the absence of a device for measuring or capturing by the user the volume of liquid added during filling. A sensor for the opening of the tank filler door is sufficient, since it can reasonably be assumed that filling is actually performed each time this door is opened by the user. As a variant, detection of the variation, i.e., of an increase in the level of liquid in the tank by any appropriate means, for example using processing applied to a signal coming from a level detector (level gauge), can replace the detection of opening of the filler door.

In an exemplary embodiment, the elementary value k2 representing the clogging risk linked to the volume of fluid pumped by the pump since the commissioning of the filtration device can be given, at step 312, by a look-up table, according to the cumulative operating time of the pump since the last filling, for the same reasons as those given above with regard to the value k1.

However, those skilled in the art will appreciate that the effects of the clogging of the filter due to a filling of the tank decrease with the cumulative operating time of the pump since such filling. Indeed, with the pump operating in a closed cycle with return to the tank of most of the pumped and continuously filtered liquid (within the amount of liquid consumed by the injector), the increase in the clogging of the filter at the rate of introduction into the tank of additional liquid, possibly carrying impurities, decreases with the operating time of the pump since such filling. This decrease is substantially exponential. The form of the response of the look-up table according to the cumulative operating time of the pump since the last filling of the tank is represented symbolically in the block representing step 312 in FIG. 3.

A third example k3 of elementary value of the clogging risk of the filtration device can be a value representing the clogging risk linked to the number of fillings of the tank since commissioning of the filtration device, determined in step 313. It will be noted again here that, by filling, we do not necessarily mean the maximum levelling of the tank, but an operation having the effect of introducing new liquid into the tank, whether or not it is in an amount sufficient to fill the tank to its maximum level.

In an exemplary embodiment, the elementary value k3 can be given by counting the number of times the filler door of the tank is opened, these openings being detected by the opening sensor of the filler door already mentioned above in relation to the elementary value k2.

Those skilled in the art will appreciate that the increase due to the clogging of the filtration device is substantially proportional to the number of fillings carried out since the filter was commissioned. In other words, the change in the value k3 as a function of the number of fillings of the tank since the filter was put into service increases in a substantially linear and monotonous manner. This evolution is symbolically represented by a rising straight line passing through zero in the block representing step 313 in FIG. 3.

Finally, a fourth and last example k4 of elementary value of the clogging risk of the filtration device can be a value representing the clogging risk linked to the pressure difference of the liquid on either side of the filtration device.

Ideally, the variation in the pressure difference of the liquid on either side of the filtration device can be measured using pressure sensors. In fact, a single pressure sensor placed between the filter 201 and the pump 204 (FIG. 2) would suffice, since it can be reasonably assumed that the pressure upstream of the filter 201, in the suction line, is equal to the pressure of the liquid in the tank, and therefore zero. However, the addition of a specific pressure sensor for this function is hardly acceptable from an economic point of view in the context of the automotive sector, where cost is always a determining factor for adopting an improvement to an existing device.

This is why the pressure difference on either side of the filter can advantageously be evaluated as a function of the variation in the operating speed of the pump at a given operating point, i.e., at a pressure and/or at a given flow rate, or possibly and in addition, at a given temperature. The idea behind this arrangement is as follows: the more the filter is clogged, the faster the pump must rotate in order to maintain the target operating point in the pressure line, that is, downstream of the pump.

For example, the value k4 representing the clogging risk linked to the pressure difference of the liquid on either side of the filtration device can be read in a look-up table indexed by a value representing the operating speed variation of the pump at a given operating point. This makes it possible to have a value k4 representing the clogging risk of the filter for any variation in speed, a small variation in the pump speed giving a low value k4 for the clogging risk or even a zero value k4, whereas a large pump speed variation would give a higher value k4 for the clogging risk. In other words, any variation in the pump speed can indicate a value k4 representing the clogging risk of the filter.

In one embodiment, a variation in the pressure difference of the liquid on either side of the filtration device is evaluated provided that a determined minimum volume of fluid has been pumped by the pump since the filtration device was commissioned or since a previous evaluation. In this embodiment, the value k4 representing the clogging risk of the filter is a function both of the variation in pump speed between two evaluations of this speed and of the volume of liquid pumped between these two evaluations. The greater the volume pumped between evaluations of the variation in pump speed, the greater the variation in speed tolerated and the lower the value k4 representing the clogging risk of the filter. In other words, the curve giving the value k4 representing the clogging risk of the filter tends to increase as a function of the variation in pump speed, but to decrease as a function of the volume of liquid pumped between two evaluations of this speed. Thus, the same speed difference for a larger volume of liquid pumped will have less impact than this same speed difference on a smaller volume of liquid pumped.

In a variant, the value k4 representing the clogging risk linked to the difference in pressure of the liquid on either side of the filtration device is linked to the number of negative results since commissioning of the filtration device, to a test of the stability of the pressure difference of the liquid on either side of the filtration device carried out at predetermined, regular or irregular time intervals since commissioning of the filtration device. The idea behind this test is that the dirtier the filter, the lower the amount of liquid it lets through for a given suction force derived from the action of the pump. Therefore, the increase in the clogging of the filter is the cause of an increase in the pressure variation between the upstream of the filter (which is at the pressure of the liquid in the tank, that is to say at zero pressure) and the downstream of the filter which is at the pressure of the pressure line 206 (FIG. 2).

Embodiments of this variant will be explored later, with reference to the process diagram of FIG. 4.

By carrying out a test of the stability of the pressure difference of the liquid on either side of the filtration device between two given instants it is possible to determine if the filter has become clogged between these two instants: if the result of the test is positive (i.e., if the pressure difference remains stable), then the filter has not become or is not significantly clogged between the two instants considered; if, conversely, the result of the stability test of the pressure difference is negative (i.e., if the pressure difference has changed, in fact decreased) it means that the filter has become significantly clogged between the two instants considered. Those skilled in the art will appreciate that the greater the number of negative test results, the more this indicates that the clogging of the filter is increasing. This is why the trend of the evolution of the value k4 as a function of the number of negative test results is represented symbolically by a rising straight line passing through zero in the block representing step 314 in FIG. 3. In practice, the curve would be flatter near the origin, reflecting a lower clogging risk for small variations in pressure than for a large variation.

The sensitivity of a test as defined above is not very high, in the sense that the clogging of the filter must be non-negligible (we can say that it must be greater than a given sensitivity threshold) in order to be reflected by a detectable change in the pressure difference across the filter. In other words, the volume of liquid which has passed through the filter between the two aforementioned instants should be greater than a certain threshold. Testing more frequently, at shorter intervals, would add nothing. This is why such a test can be carried out only each time a determined volume of fluid has passed through the filter, that is, has been pumped by the pump since the last test was performed. To determine this, the control module can integrate the theoretical value of the pump flow over time, over the operating time of the pump elapsed since commissioning of the filter (for the very first test that is carried out) or since the last test performed (for subsequent tests). In addition, the frequency of the tests does not need to be homogeneous over the operating time of the pump elapsed since commissioning of the filter: in fact, at the beginning the clogging risk is low, then it increases exponentially from a certain volume pumped since commissioning of the filter. This is why the threshold at which the volume of liquid pumped since commissioning of the filter (for the very first test which is carried out) or since the last test carried out (for subsequent tests), can be variable.

The embodiments mentioned above, and others, will be explained below with reference to the process diagram of FIG. 4.

Still with reference to FIG. 3 for the moment, those skilled in the art will appreciate that the elementary values k1, k2, k3 and k4 of the clogging risk of the filter can each have different relative incidences in the composition of the compound value K which results from their addition. If the compound value K takes a real value between 0 and 1, a fair distribution of the incidence of the elementary values k1, k2, k3 and k4 would lead to these elementary values each evolving in a dynamic range between 0 and 0.25, whereas it is possible to “favour” one of the elementary values by giving it a greater dynamic range than those of the other elementary values. For example, if k1, k2 and k3 each have a dynamic range between 0 and 0.10 whereas k4 has a dynamic range between 0 and 0.70 (so that the sum K of k1, k2, k3 and k4 has a dynamic range always between 0 and 1), then the elementary value k4 makes a relatively higher contribution and therefore has a relatively greater impact than the other elementary values k1, k2 and k3 in the final compound value K. In other words, it is possible to give respective weights to the different elementary values k1, k2, k3 and k4 of the clogging risk of the filter by giving them respective dynamic ranges specific to each one. More generally, each of the elementary values k1, k2, k3 and k4 is configurable through the dynamic range assigned to it. One example of the use of this characteristic consists in configuring the device for evaluating the clogging risk of the filter according to the type of vehicle and/or according to the type of use expected of the vehicle, by choosing particular respective dynamic ranges for elementary values. For example, if the vehicle is a construction lorry which is filled from a portable tank on a work site, a relatively greater weight can be given to the elementary value k3 than for a road transport lorry that mainly fills its tank in service stations in motorway service areas. Indeed, the risk of bringing impurities (dust, sand, etc.) into the tank during filling is higher in the first case than in the second.

In addition, those skilled in the art will appreciate that the value of the sum of the elementary values k1, k2, k3 and k4 of the clogging risk can be limited to a maximum admissible value for comparison of the compound value K of the clogging risk to the threshold value Th(Pa) in step 340, before carrying out said comparison. This may be necessary if the sum of the dynamic ranges of the respective elementary values k1, k2, k3 and k4 is not limited upwards, or because at least one of the respective dynamic ranges of the elementary values is not limited upwards, or because the number of elementary values taken into account is variable without adjustment of their respective dynamic ranges intended to ensure that the dynamic ranges of their sum remains between 0 and 1. This falls within the know-how of those skilled in the art of computer programming, insofar as the steps of the method are implemented by a computer program.

The process diagram in FIG. 4 illustrates the evaluation of the fourth criterion of clogging risk of the filtration device, namely the evaluation of the compound value k4, according to possible embodiments. It is recalled that this risk criterion is determined by a value linked to the number of negative results since commissioning of the filtration device obtained from a stability test of the difference in pressure of the liquid downstream and upstream of the filtration device, carried out at determined time intervals, which may be regular or not.

The following acronyms and notations are used in the diagram of FIG. 4:
PV denotes the volume of aqueous liquid pumped by the pump 204 of FIG. 1. This value is obtained by integrating the value of the theoretical flow rate of the pump over the operating time of the pump from a certain origin. This origin initially corresponds to the commissioning of the filter, then it corresponds to the performance of a test according to the method which will now be described;
Vref designates a threshold volume of aqueous liquid pumped by the pump from which a new test can be carried out, that is, below which a test would have no significant relevance with regard to the criterion of clogging of the filter in question;
t designates the time, counted from a determined time reference, that is, from a given instant at which this variable t is initialised to zero;
PS; designates an observed value of the pump speed, within a series of such values comprising a number M of values observed successively, therefore for i comprised between 1 and M;
P designates the value of pressure in the pressure line 206. The operating point of the liquid extraction system is considered stable if this value is between a minimum value Pmin and a determined maximum value Pmax;
Tref designates a threshold duration of a state of stability of the operating point of the extraction system, from which it is possible to make a valid measurement of the pump speed;
APS or ΔPS_{j/j-1} designates the variation in pump speed between two successive measurements PSⱼ and PSⱼ₋₁ of this speed, respectively;
Th_{ΔPS} designates a threshold for comparison, with which the variation in pump speed is compared in order to determine whether the stability criterion for this speed, and therefore the stability criterion for the pressure difference on either side of the filter, is satisfied or not. In one embodiment, this threshold Th_{ΔPS} depends on the volume of liquid filtered by the pump since commissioning of the pump, in order to overcome phenomena of pump wear which can have an effect on its speed of rotation which is not correlated to the pressure difference across the filter. Such a wear phenomenon may be due, for example, to the wear of the bearings of the axis of rotation of the pump; or any other wear of the mechanical and/or electromagnetic parts of the pump such as the insulation of its windings;
N designates the number of failures of the stability test of the pressure difference on either side of the filter. This number is incremented each time such a test gives a negative result, i.e., each time the pump speed variation ΔPS compared to the last test previously carried out is greater than the threshold Th_{ΔPS}; and, finally,
avg denotes an “average” mathematical operator.

With reference to FIG. 4, step 401 of the test of variation in pressure on either side of the filter (hereinafter the test) comprises the continuous estimation of the volume of aqueous liquid pumped by the pump from the motor vehicle tank through the filter, since the initialisation or the last reset of the corresponding PVvalue. The PVvalue is initialised when the filter is commissioned, and a reset takes place at step 413 (see below) each time a test has been carried out, whether the result is positive or negative. The PV value is measured by integrating the value of the theoretical flow of the pump over the operating time of the pump since the initialisation or last reset of the PV value.

In step 402, the initialisation or the last reset of the PV value is compared to the threshold V_{ref}. The purpose of this step is to verify that the volume of aqueous liquid pumped by the pump since the initialisation or last reset of the PV value has exceeded the threshold from which a new test can be carried out, which has a significant relevance with regard to the clogging criterion of the filter considered.

If so, the process proceeds to step 403, in which the time counter t is set or reset to zero in order to start a new test, and in which, if applicable, all the PSᵢ values for i comprised between 1 and M determined during a previous test are reset to zero.

Then, in step 404, the absence of injection 209 of liquid additive is checked by the injector 208 in the exhaust gas treatment system, from the pressurised line 206 (see FIG. 2). The purpose of this check is to ensure that the liquid extraction system operates in a closed loop, with all liquid pumped from the tank returning to the tank and no portion of that liquid being consumed by injector 208.

In the same step 404, the pressure in the pressure line is also checked for stability, that is, that it lies within the interval [Pmin, Pmax]. This can be checked by measuring the pressure in the pressure line with the pressure sensor 210.

If either of the two conditions above evaluated at step 404 is not verified, this means that the operating point of the pump is not stable and that the test will give no conclusive result relative to the clogging criterion of the filter considered. This is why in this case, the process loops back to step 403 where the counter t and the measurements PS; are reinitialised. Otherwise, the time counter t increments regularly.

In step 405, the time t elapsed since the liquid extraction system is at a stable operating point is verified to be greater than the threshold duration T_{ref}. As long as this is not the case, step 406 proceeds to the measurement of a value PS; of the pump speed, which is stored. In other words, PS; values are accumulated until a number M of PSᵢ values is obtained (i.e., until i=M) at the end of the time interval T_{ref}.

When the duration T_{ref} has elapsed, the verification of step 405 gives a positive result and, at step 407, the average of the M accumulated values PSᵢ is then calculated, that is, the average of the PSᵢ; values, for i ranging from 1 to M. The purpose of this average is to smooth the pump speed measurements taken during each iteration of step 406 in order to overcome any isolated phenomenon. Such an isolated phenomenon can be, for example, a hard point in the axis of rotation of the pump causing a temporary drop in pressure in the pressure line 206, or any other random phenomenon of this type having an effect on the rotation speed of the pump and/or on the pressure in the pressure line.

In step 408, it is then possible to calculate the difference ΔPS or ΔPS_{j/j-1} between the average value of the pump speed that has just been calculated at step 407 (PSⱼ) and the average value of the pump speed which had been calculated during the previous iteration of the test (PSⱼ₋₁).

It is then possible to compare this difference ΔPS with the threshold Th_{ΔPS}, in step 410, in order to determine whether the criterion of stability of the pump rotation speed, and therefore the criterion of stability of the pressure difference on either side of the filter, is satisfied or not. In one embodiment, in step 409, the threshold Th_{ΔPS} is determined as a function of the PV volume pumped between two tests.

If the pump speed difference ΔPS is less than the threshold Th_{ΔPS} (ΔPS<Th_{ΔPS}), then the stability test of the pressure difference on either side of the filter is considered successful. In other words, we note that the pressure difference has not varied significantly, which indicates that the filter is not significantly clogged since the last test performed. In this case, in step 412 the current mean value PSⱼ of the pump speed calculated in step 407 replaces the mean value PSⱼ₋₁ that had been calculated during the previous iteration of the test, in view of the next iteration of the test, and further, in step 413, the PV value of the volume of liquid pumped is reset and the test is terminated. Another test can be started by looping back to step 401, so as to wait until a new volume V_{ref} of liquid has been pumped.

If, conversely, the pump speed difference ΔPS is greater than the threshold Th_{ΔPS} (ΔPS>Th_{ΔPS}), then the stability test of the pressure difference on either side of the filter is considered to have failed. In other words, we note that the pressure difference has varied significantly, which indicates that the filter has become significantly clogged since the last test carried out. In this case, at step 411, the count N of failed tests is incremented (N=N+1).

In addition, step 412 is also carried out such that the current average value PSⱼ of the pump speed calculated in step 407 replaces the average value PSⱼ₋₁ calculated during the previous iteration of the test, in preparation for the next iteration of the test. The process then also proceeds to step 413 where the PV value of the volume of liquid pumped since the last test is reset and the test is terminated. Another test can be started by looping back to step 401, so as to wait until a new volume V_{ref} of liquid has been pumped.

The invention has been described above in the context of non-limiting embodiments. A person skilled in the art will appreciate, in particular, that the risk criteria respectively associated with the elementary values k1, k2, k3 and k4 presented in the preceding description are non-limiting examples. A person skilled in the art will be able to choose other criteria that they consider significant for estimating the overall clogging risk of the filtration device. Thus, advantageously, the number and type of risk criteria used can be adapted to a specific use case of a liquid filtration system and more broadly of a liquid extraction system to take account of real conditions of use. In other words, the conditions for triggering the steps of the method can be configured by a user according to the expected use of the vehicle in which the liquid extraction system is installed.

Moreover, in a particular mode of implementation, a determined weight (in the mathematical sense, that is to say a weighting coefficient) can be respectively associated with each risk criterion k1, k2, k3 and k4 and the detection of clogging of the filtration device can be carried out on the basis of the risk criteria weighted by the weights respectively associated with each risk criterion. In other words, the effective detection of clogging of the filtration device assumes that the accumulation of the weighted values of the various risk criteria observed is sufficiently high (that is to say by being greater than a threshold value). This weighting system thus makes it possible to grant more or less relative importance to the various elementary risk criteria used to detect clogging of the filter. Here again, advantageously, the different weights associated with the different criteria can be parametrised prior to the use of the method so as to adapt the detection of clogging as precisely as possible to a specific use case of the filtration device. For example, depending on whether the vehicle in which the system is installed is intended for use on the road or not, the various risk criteria can have a different impact on the overall performance of the system.

In another embodiment, the information associated with a need to change the filtration device can be stored in a non-volatile memory for diagnostic purposes, and/or an alert indicating the need to replace the filtration device can be issued via a man/machine interface of the vehicle. This alert can be the lighting of a warning light or the emission of a visual or audible message. This alert can also take a graduated form, depending on the compound value K of the clogging risk. For example, the K value can be displayed as a percentage, i.e., between 0% and 100%, so that the user can decide whether or not to replace the filter before or after the 100% threshold is reached, according to their own sensitivity to the risk of degradation of the performance of the exhaust gas treatment system associated with the evaluation of the clogging risk of the filter provided by the implementation of the invention. As a variant or in addition, information relating to the K value of the clogging risk of the filter can be displayed with a colour code reflecting the degree of risk: for example in green for a K value of less than 80%, in orange for a K value between 80% and 90%, and in red for a K value greater than 90%.

In the claims, the term “comprising” or “including” does not exclude other elements or other steps. A single processor or several other units can be used to implement the invention. The various characteristics presented and/or claimed can be advantageously combined. Their presence in the description or in different dependent claims does not exclude this possibility. The references cannot be understood as limiting the scope of the invention.

1. A method for evaluating a service interval for replacing a filtration device of an extraction system for extracting an aqueous liquid from a tank of a motor vehicle, in response to a risk of progressive clogging of said filtration device due from use, wherein the method comprises:
generating a compound clogging risk decision value based on a sum of a plurality of elementary clogging risk values, at least one of said plurality of elementary clogging risk values being linked to a risk criterion, said risk criterion depending on the operation of said extraction system since a commissioning of said filtration device;
comparing of said compound clogging risk decision value with a threshold value; and,
producing an alert for replacing the filtration device if the compound clogging risk value exceeds said threshold value, wherein the plurality of elementary clogging risk values comprises:
A first value “k2” representing a first clogging risk linked to a volume of liquid pumped by the pump since a last filling of the tank, and
a second value “k3” representing a second clogging risk linked to a number of times the tank has been filled since said commissioning of the filtration device.

2. The method of claim 1, wherein the extraction system further comprising a pump with a first port connected to the tank via the filtration device and a suction line and a second port connected to an injection device via a delivery line, as well as a return line connected to the delivery line by its first end and opening into the tank by its second end, and the filtration device being arranged on the suction side of the pump, the plurality of elementary clogging risk values comprises a third value “k1” representing the clogging risk linked to the volume of liquid pumped by the pump since commissioning of the filtration device.

3. The method of claim 1, wherein the plurality of elementary clogging risk values comprises a third value “k4” representing the clogging risk linked to the variation in the pressure difference of the liquid on either side of the filtration device.

4. The method of claim 1, wherein the plurality of elementary clogging risk values comprises a third value “k4” representing the clogging risk linked to the variation in the pressure difference of the liquid on either side of the filtration device, and wherein a variation in the pressure difference of the liquid on either side of the filtration device is evaluated as a function of the variation in the pump operating speed at a given operating point.

5. The method of claim 1, wherein the plurality of elementary clogging risk values comprises a third value “k4” representing the clogging risk linked to the variation in the pressure difference of the liquid on either side of the filtration device and wherein a variation in the pressure difference of the liquid on either side of the filtration device is evaluated provided that a determined minimum volume of fluid has been pumped by the pump since the filtration device was commissioned or since a previous evaluation.

6. The method of claim 1, wherein the plurality of elementary clogging risk values comprises a third value “k4” representing the clogging risk linked to the variation in the pressure difference of the liquid on either side of the filtration device, wherein a variation in the pressure difference of the liquid on either side of the filtration device is evaluated provided that a determined minimum volume of fluid has been pumped by the pump since the filtration device was commissioned or since a previous evaluation, and wherein the elementary clogging risk values can be parametrised according to the type of vehicle and/or according to the type of use expected of the vehicle.

7. The method of claim 1, wherein the alert for replacing the filtration device is displayed via a man/machine interface of the vehicle to indicate to a vehicle user the need to replace the filtration device.

8. The method of claim 1, wherein the alert for replacing the filtration device is stored in a non-volatile memory of the vehicle, for indicating to an operator responsible for the maintenance of the vehicle the need to replace the filtration device.

9. A control unit of a system for extracting a liquid from a tank of a motor vehicle, said control unit comprising means for implementing the method of claim 1.

10. An extraction system for extracting an aqueous liquid from a motor vehicle tank comprising a pump and a filtration device, said pump comprising a first port connected to the tank via the filtration device and a suction line and a second port connected via a discharge line to an injection device of liquid capable of consuming liquid extracted from the tank, said extraction system further comprising a return line connected to the delivery line by a first end and connected to the tank by a second end, as well as a control unit of a system for extracting a liquid from a tank of a motor vehicle, comprising means for implementing the method of claim 1, for evaluating a service time interval for replacing the filtration device.

11. The extraction system of claim 10, wherein said extraction system is adapted to extract a liquid additive from a dedicated tank of a motor vehicle and to inject said liquid additive into an exhaust gas treatment system of said motor vehicle.

12. An exhaust gas treatment system of a motor vehicle comprising the extraction system of claim 10, wherein said extraction system is adapted to extract a liquid additive from a dedicated tank of a motor vehicle and to inject said liquid additive into an exhaust gas treatment system of said motor vehicle.

13. A non-transitory computer readable medium having stored thereon instructions of a computer program for implementing the method according to claim 1 when said instructions are executed by a processor.
